(19) United States
(12) Patent Application Publication
(10) Pub. No.: US 2018/0251585 A1
(43) Pub. Date: Sep. 6, 2018

(54) PROCESS FOR THE PREPARATION OF A POLYOLEFIN HAVING ONE OR MULTIPLE PENDING FUNCTIONALITIES

(71) Applicant: SABIC Global Technologies B.V., Bergen op Zoom (NL)

(72) Inventors: Miloud Bouyahyi, Eindhoven (NL); Robbert Duchateau, Eindhoven (NL); Lidia Jasinska-Walc, Eindhoven (NL); Martin Alexander Zuideveld, Kelmis (BE)

(21) Appl. No.: 15/746,955

(22) PCT Filed: Jul. 22, 2016
(86) PCT No.: PCT/EP2016/067527

§ 371 Date: Jan. 23, 2018

(30) Foreign Application Priority Data
Jul. 23, 2015 (EP) 15177975.8

(51) Int. Cl. C08F 210/16; C08F 4/659; C08F 2/38

(52) U.S. Cl. CPC C08F 210/16; C08F 4/65912; C08F 2500/09; C08F 2410/01; C08F 2500/04; C08F 2/38

(57) ABSTRACT

The present invention relates to a process for the preparation of branched polyolefins having pending polar functionalities via the copolymerization of first an olefin monomer and second an olefin monomer comprising a main group metal hydrocarbyl functionality agent. The invention moreover relates to branched polyolefin having short chain branches with polar functionalities.

The present invention relates to a process for the preparation of polyolefins having one or multiple pending functionalities via the copolymerization of an olefin monomer and an olefin bearing a main group metal hydrocarbyl functionality according to Formula 1a. The invention moreover relates to polyolefin having one or multiple pending functionalities obtained by said process, whereby such polyolefin may also be considered branched polyolefin especially for example with preferably short branches and functionalized branch ends.

### BACKGROUND

The present invention relates to the preparation of a polyolefin having one or multiple pending functionalities, the intermediate products and the processes to obtain these products.

Commercially available polyethylene and polypropylene prepared using standard procedures with Ziegler-Natta or metallocene catalysts have a predominantly linear molecular structure. Although linear polyolefins have many desirable physical properties, they show a variety of melt processing shortcomings, especially the metallocene prepared ones having narrow molecular weight distributions, which typically have a low melt strength. Low melt strength is a problem because it causes local thinning in melt thermoforming, relative weakness in large-part blow molding and flow instabilities in co-extrusion of laminates.

One way of overcoming the shortcomings of linear polyolefins is by means of branching, viz. the provision of polymer side chains extending from the polyolefin backbone.

Despite their ubiquitous presence in our society, polyolefins such as polyethylene and polypropylene are not appropriate for several applications as a consequence of their inherently nonpolar character. This nonpolar character is the reason for the poor adhesion, printability and compatibility that can restrict their efficacy. Hence, it is further desirable to prepare polyolefins bearing for example polar groups so to ensure a good adhesion and printability.

Polymers with functionalized short chain branches can be prepared using different methodologies. The most common method consists of the copolymerization of a monomer, for example ethylene or propylene, with a comonomer containing a nucleophilic functionality, for example a hydroxyl or carboxylic acid functionality. The major disadvantage of this approach is that the nucleophilic functionality typically poisons or partially deactivates the catalyst. Alternatively, polymers with functionalized short chain branches can be prepared by the copolymerization of a monomer with a comonomer containing an electrophilic functionality, for example a borane or main group metal functionality, followed by the oxidation of the thus obtained polymeric intermediates.

In the prior art cyclic olefin copolymers (COC) have thus for example already been prepared by the copolymerization of norbornene with an ω-alkenylaluminium comonomer to afford after oxidation with gaseous oxygen short chain branched cyclic olefin copolymers with some hydroxyl functionalized short chain branches (see Shiono et al., Macromol. Chem. Phys., 2013, 214, 2239-2244).

However, COCs are expensive and their processing is not easy, especially as it requires quite high temperatures. Moreover, the use of gaseous oxygen may be dangerous and thus difficult the use, especially at a larger scale and/or under high pressure.

The present invention is directed towards an easy, catalyst-compatible, relatively inexpensive and safe process that can be used for large scale preparation polyolefins having one or more pending functionalities, which are easily processable and can preferably be blended with for example PP or PE.

### SUMMARY OF THE INVENTION

In a first aspect, the present invention relates to a process for the preparation of a polyolefin having one or more pending polar functionalities, said process comprising the step of:
A) a polymerization step comprising copolymerizing at least one first type of olefin monomer, preferably selected for example from ethylene or propylene, and at least one second type of olefin monomer comprising a main group metal hydrocarbyl functionality according to Formula 1a: R¹⁰⁰₍ₙ₋₂₎R¹⁰¹Mⁿ⁺R¹⁰² using a catalyst system to obtain a polyolefin; wherein said catalyst system comprises a catalyst or catalyst precursor comprising a metal from Group 3-10 of the IUPAC Periodic Table of elements that does not lead to chain transfer polymerization with the main group metal hydrocarbyl functionality of the second type of olefin monomer, and
   wherein further M is a main group metal; n is the oxidation state of M; R¹⁰⁰, R¹⁰¹ and R¹⁰² of Formula 1a are each independently selected from the group consisting of a hydride, a C1-C18 hydrocarbyl group, or a hydrocarbyl group Q on the proviso that at least one of R¹⁰⁰, R¹⁰¹ and R¹⁰² is a hydrocarbyl group Q, wherein hydrocarbyl group Q is according to Formula 1b:

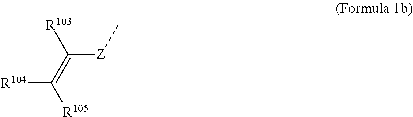

wherein Z is bonded to M and Z is a C1-C18 hydrocarbyl group; R¹⁰⁵ optionally forms a cyclic group with Z; wherein R¹⁰³ and R¹⁰⁴ and R¹⁰⁵ are each independently selected from hydrogen or a hydrocarbyl group; and at least one step of:
B) an oxidizing step comprising contacting said polyolefin obtained in step with at least one oxidizing agent to obtain a polyolefin having one or more pending oxidized functionalities; and/or
C) contacting said polyolefin obtained in step B) with at least one quenching agent to obtain a polyolefin having one or more pending polar functionalities.

A polyolefin having one or more pending polar functionalities may be a polyolefin having a backbone preferably for example made of ethylene or propylene as well as of an olefin monomer comprising a main group metal hydrocarbyl functionality. The second type of olefin monomer comprising a main group metal hydrocarbyl functionality can thereby comprise a spacer, like for example a substituted and/or unsubstituted alkyl chain and/or bridged or unbridged, substituted and/or unsubstituted, cyclic hydrocarbon, linking the olefin and the main group metal hydrocarbyl functionality. The second type of olefin monomer comprising a main group metal hydrocarbyl functionality can thereby comprise bridged or unbridged, substituted and/or unsubstituted, cyclic hydrocarbon as a spacer for example when a reactive cyclic olefin, especially for example a norbornene derivative comprising a main group metal hydrocarbyl functionality is used as the second type of olefin monomer. The second type of olefin monomer and/or the corresponding spacer can thus in turn lead to short branches along the backbone. A/each polyolefin branch or short chain branch can thus for example preferably comprise a substituted and/or unsubstituted alkyl chain and/or bridged or unbridged, substituted and/or unsubstituted, cyclic hydrocarbon comprising 1 to 25 carbon atoms, further preferred 2 to 20 carbon atoms, further preferred 3 to 17, further preferred 4 to 10 carbon atoms, preferably for example linking a function that is incorporated into the polyolefin backbone or main chain to at least one polar function. A main chain or backbone may thereby be a polymer chain comprising C—C bonds coming from the copolymerization of the first type of olefin monomer and the second type of olefin monomer. On the other hand, a short chain or short chain branch may correspond to the spacer between the olefin of a second type of olefin monomer and the main group metal hydrocarbyl functionality of the same. A main chain or backbone can thus preferably consist of a polymer chain comprising C—C bonds, to which other shorter chains of the second type of olefin monomer may be regarded as being pendant to. In turn, the shorter chains of the second type of olefin monomer can thus be considered as representing branches, especially short chain branches, with respect to the backbone. In the present invention, both the main chain and the short chain branches can be obtained together in step A).

As already explained before, the present invention specially deals with short branches that may for example correspond to a spacer, especially for example a substituted and/or unsubstituted alkyl chain and/or bridged and/or unbridged, substituted and/or unsubstituted, cyclic hydrocarbon, between the olefin and the main group metal hydrocarbyl functionality of the second type of olefin monomer. As the olefins of the second type of olefin monomers get incorporated in the backbone or main chain, the spacers and the main group metal hydrocarbyl functionalities for example at the end of the spacers of these monomers may form pending short branches that are pending from the backbone or main chain. A short branch may thereby be a side chain with a length shorter than the length of the main chain that can mean that a short chain branch can have a length corresponding a less than 20% of the length of the backbone in terms of carbon atoms, monomer units and/or average molecular weight (Mn or Mw). A short chain branch can also preferably for example comprise <100 carbon atoms in the backbone of the long chain branch. A short chain branch can also preferably for example be short enough to avoid entanglement phenomena, preferably involving the branch, to occur.

Pending polar functionalities may mean a functionality that preferably comprises at least one heteroatom that is different from carbon and hydrogen. Such a heteroatom may thereby be preferably more electronegative than carbon and/or hydrogen. A polar functionality can especially comprise for example a hydroxyl, carboxylic acid or halogen functionality.

A heteroatom may be preferably for example selected from Group 14, 15 or 16 of the IUPAC Periodic Table of the Elements and can as used in the present description for example especially mean a hetero atom selected from Si, Ge, Sn [Group 14], N, P, As, Sb, Bi [Group 15], O, S, Se, Te [Group 16] or halogens.

Hydrocarbyl as used in the present description may means: a substituent containing hydrogen and/or carbon atoms; it may for example be a hydride or a linear, branched or cyclic saturated or unsaturated aliphatic substituent, such as for example alkyl, alkenyl, alkadienyl and alkynyl; alicyclic substituent, such as cycloalkyl, cycloalkadienyl cycloalkenyl; aromatic substituent or aryl, such as for example monocyclic or polycyclic aromatic substituent, as well as combinations thereof, such as alkyl-substituted aryls and aryl-substituted alkyls. It may be substituted with one or more non-hydrocarbyl, heteroatom-containing substituents or heteroatoms. Hence, when in the present description hydrocarbyl is used it can also mean a substituted hydrocarbyl, unless stated otherwise. Included in the term “hydrocarbyl” are also perfluorinated hydrocarbyls wherein all hydrogen atoms are replaced by fluorine atoms. A hydrocarbyl may moreover for example be present as a group on a compound (hydrocarbyl group) or it may be present as a ligand on a metal (hydrocarbyl ligand).

Alkyl as used in the present description means: a group consisting of carbon and hydrogen atoms having only single carbon-carbon bonds. An alkyl group may be straight or branched, un-substituted or substituted. It may contain aryl substituents. It may or may not contain one or more heteroatoms.

Aryl as used in the present description means: a substituent derived from an aromatic ring. An aryl group may or may not contain one or more heteroatoms. An aryl group also encloses substituted aryl groups wherein one or more hydrogen atoms on the aromatic ring have been replaced by hydrocarbyl groups.

Hydride as used in the present description may mean: a hydrogen anion bonded to a metal.

In an embodiment, at least one of R¹⁰⁰, R¹⁰¹ and R¹⁰² of Formula 1a can be a hydrocarbyl group Q and the remaining groups of R¹⁰⁰, R¹⁰¹ and R¹⁰² are each a C1-C10 hydrocarbyl group or wherein two groups of R¹⁰⁰, R¹⁰¹ and R¹⁰² are each a hydrocarbyl group Q and the remaining group of R¹⁰⁰, R¹⁰¹ and R¹⁰² is a C1-C10 hydrocarbyl group, preferably a C1-C4 hydrocarbyl group, or wherein all of R¹⁰⁰, R¹⁰¹ and R¹⁰² are a hydrocarbyl group Q. Expressions like for example “C1-C4” or “C1-C16” and similar formulations may refer to a range regarding a number of carbon atoms, here for example respectively from 1 to 4 or from 1 to 16 carbon atoms.

In an embodiment, a second type of olefin monomer comprising a main group metal hydrocarbyl functionality can be selected from the group consisting of bis(isobutyl)(5-ethylen-yl-2-norbornene) aluminum, di(isobutyl)(7-octen-1-yl) aluminum, di(isobutyl)(5-hexen-1-yl) aluminum, di(isobutyl)(3-buten-1-yl) aluminum, tris(5-ethylen-yl-2-norbornene) aluminum, tris(7-octen-1-yl) aluminum, tris(5-hexen-1-yl) aluminum, or tris(3-buten-1-yl) aluminum, ethyl(5-ethylen-yl-2-norbornene) zinc, ethyl(7-octen-1-yl) zinc, ethyl(5-hexen-1-yl) zinc, ethyl(3-buten-1-yl) zinc, bis(5-ethylen-yl-2-norbornene) zinc, bis(7-octen-1-yl) zinc, bis(5-hexen-1-yl) zinc, or bis(3-buten-1-yl) zinc. A cyclic unsaturated hydrocarbyl group can thereby lead for example to a high reactivity.

In an embodiment, the catalyst or catalyst precursor used in step A) may comprise a metal from Groups 3-10 of the IUPAC Periodic Table of elements, more preferably from Groups 3-8 from Groups 3-6 and/or wherein the metal catalyst or metal catalyst precursor used in step A) comprises a metal selected from the group consisting for example of Ti, Zr, Hf, V, Cr, Fe, Co, Ni, Pd, preferably Ti, Zr or Hf.

In an embodiment, said catalyst can be a Ziegler-Natta catalyst, such as for example titanium-magnesium and aluminum based Ziegler-Natta catalysts, especially obtained for example by reacting a titanium alkoxy with a magnesium alkoxy and subsequently reaction the reaction product with an aluminum alkyl halide, or a catalyst based on a Group 4 metal, which can especially be for example a metallocene, half-metallocene or a post-metallocene and/or a single-site catalyst.

In an embodiment, a catalyst precursor can be for example a Cₛ-, C₁- or C₂-symmetric zirconium or hafnium metallocene, preferably an indenyl substituted zirconium or hafnium dihalide, more preferably a bridged bis-indenyl zirconium or hafnium dihalide, even more preferably rac-dimethyl silyl bis-indenyl zirconium or hafnium dichloride (rac-Me₂Si(Ind)₂ZrCl₂ and rac-Me₂Si(Ind)₂HfCl₂, respectively), or rac-dimethylsilyl bis-(2-methyl-4-phenyl-indenyl) zirconium or hafnium dichloride (rac-Me₂Si(2-Me-4-Ph-Ind)₂ZrCl₂ and rac-Me₂Si(2-Me-4-Ph-Ind)₂HfCl₂, respectively).

In an embodiment, said catalyst precursor can be for example a so-called half-metallocene, or constrained geometry catalyst, even more preferably, C₅Me₅[(C₆H₁₁)₃P═N]TiCl₂, [Me₂Si(C₅Me₄)N(tBu)]TiCl₂, [C₅Me₄(CH₂CH₂N Me₂]TiCl₂. In an embodiment, said catalyst can be for example a so-called post-metallocene, preferably [Et₂NC(N(2,6-iPr₂-C₆H₃)]TiCl₃ or [N-(2,6-di(1-methylethyl)phenyl)amido)(2-isopropylphenyl)(α-naphthalen-2-diyl(6-pyridin-2-diyl)methane)]hafnium dimethyl.

For example oxygen, ozone or oxygen-containing gas mixtures such as air or synthetic air or mixtures of oxygen with other gases can be used as oxidizing agents in step B).

Moreover, at least one safe oxidation agent can for example be used as oxidizing agent or safe oxidizing agent in step B).

In an embodiment, at least safe oxidizing agent according to the invention used in step B) can for example be preferably selected from the group consisting of CO, CO₂, CS₂, COS, N₂O and SO₃ or R²NCO, R²NCS, R²NCNR³, CH₂═C(R²)C(═O)OR³, CH₂═C(R²)(C═O)N(R³)R⁴, CH₂═C(R²)P(═O)(OR³)OR⁴, R²CN, R²NC, epoxide, aziridine, cyclic anhydride, R³R4C═NR², R²C(═O)R³, ClC(═O)OR², preferably, N₂O, CO₂ and SO₃ or mixtures of at least two or more thereof, even more preferably CO₂. A safe oxidizing agent in the sense of the present invention, can thereby be for example be an compound where at least one oxygen or sulphur is bound at least one other atom than oxygen or sulphur and/or a compound comprising at least one nitrogen-carbon CN double or triple bond. Using safe oxidants according to the present invention thereby allows reducing the process risk (especially for example the risk of fire and explosions) associated with the use of the oxidizing agent, so as to be able to easily scale up the reactions and/or use high pressures. Using more than one oxidizing agents can thereby for example lead to polymers having at least two or more different polar functionalities.

The inventors could thereby surprisingly show that the use of safe oxidizing agents did lead to an oxidation and/or functionalization yield equal or higher than with gaseous oxygen or oxygen containing gas mixtures could be obtained. For example, the oxidation yield may thereby be the functionalization yield or degree of functionalization or percentage functionalization, whereby these three expressions may be used synonymously. Oxidation and/or functionalization yield can thereby preferably for example be at least >30% or >50%, preferred >60%, further preferred >70% or even further preferred >80%.

In a second aspect, the invention relates to a polyolefin having a content of polar functionalities of for example at most 0.1 mol-%, at most 1 mol-%, at most 3 mol-%, at most 5 mol-%, 10 mol-% and/or at least 0.001 mol-%, at least 10 mol-%, at least 15 mol-%, 25 mol-%, preferably at least 30 mol-%.

During step C) a quenching agent can be used to obtain preferably a polar function, like for example a hydroxyl function at the branches.

In an embodiment, the reagent is a protic reagent. In a preferred embodiment the protic agent is water or an alcohol or a mixture thereof, preferably water.

It is possible that in a specific embodiment instead of a hydrolysis another type of quenching step is carried out. Said step is then preferably carried out using a non-protic metal-substituting quenching agent.

The present invention will be described in more detail below.

### DETAILED DESCRIPTION OF THE INVENTION

The key of the present invention is the copolymerization of an olefin monomer, preferably ethylene or propylene, and at least one second type olefin monomer, preferably also α-olefin, containing a main group metal hydrocarbyl functionality.

This can for example be used for the preparation of polyolefins having pending polar functionalities via an additional oxidation step.

Thus, it can be said that the end product that is desired in the present invention is a polyolefin having one or multiple preferably short branches, preferably with polar functions for example at the ends. The copolymer obtained in step A) can thereby to be oxidized and/or optionally subsequently quenched to produce the desired end product.

The present invention uses an olefin-comprising main group metal hydrocarbyl as comonomer. In other words, the olefin-comprising main group metal hydrocarbyl can be, for example, an alkene-comprising aluminum hydrocarbyl or an alkene-comprising zinc hydrocarbyl.

Step A):

The first step in the process according to the present invention is the preparation of a polyolefin having one or multiple main group metal functionalized branches by polymerizing at least one first type of olefin monomer, preferably a α-olefin, and at least one second type of olefin monomer, preferably a α-olefin, comprising a main group metal hydrocarbyl functionality with a metal catalyst that does not lead to chain transfer polymerization with the main group metal hydrocarbyl functionality of the second type of olefin monomer, optionally a co-catalyst, optionally a scavenger and optionally one or more chain transfer agents and/or chain shuttling agents. In an embodiment, said main group metal hydrocarbyl functionality or a corresponding functionality can for example be an alkenyl-comprising aluminum hydrocarbyl or a corresponding functionality.

The second type of olefin monomer can comprise a main group metal hydrocarbyl functionality, which can for example be a reactive electrophilic metal end group. The resulting polyolefin can have one or multiple branches comprising at least reactive electrophilic metal functionalities, preferably for example at the end of the branch(es). In other words, said product is a branched polyolefin that is functionalized on at least one of its branches with a main group metal.

A “main group metal” as used in the present description can refer to/mean: a metal that is an of a main group, namely an element of groups 1, 2, and 13-15 of the period table or zinc. In other words, metals of:
Group 1: lithium (Li), sodium (Na), and potassium (K)
Group 2: beryllium (Be), magnesium (Mg), and calcium (Ca)
Group 13: boron (B), aluminum (Al), gallium (Ga), and indium (In)
Group 14: germanium (Ge), and tin (Sn)
Group 15: antimony (Sb), and bismuth (Bi) of the IUPAC Periodic Table of elements
main group metals also include for the context of the present invention zinc (Zn).

During the polymerization reaction according to step A) at least one olefin comprising a main group metal hydrocarbyl functionality (being for example a main group metal atom bearing one or more hydrocarbyl and/or hydride groups and at least one alkenyl group) is used. The product obtained in step A) is then a polyolefin having one or multiple main group metal-functionalized branches (being a branched polyolefin that is functionalized on at least one of its branches with a main group metal). This is considered to be the main product of step A), which is an intermediate product in the process according to the present invention.

The catalyst system used in step A) comprises: i) a Group 3-10, preferably Group 3-8 and more preferably Group 3-6, metal catalyst or metal catalyst precursor as well as optionally one or more of ii) a co-catalyst, iii) a scavenger and/or iv) optionally one or more chain transfer agents and/or chain shuttling agents.

According to the present invention, the catalyst can be selected, preferably so that it does not lead to an interaction, especially not to poisoning and/or to chain transfer polymerization, with the main group metal hydrocarbyl functionality of the second type of olefin monomer. A catalyst that does not lead to an interaction and/or to chain transfer polymerization may thereby preferably for example be a catalyst that does not lead to interaction products detectable by NMR and/or to chain transfer products detectable by NMR. An example of a selection made in that way, may be the selection of a catalyst comprising zirconium (Zr) or titanium (Ti) as the metal, for example a phenoxy-imine based Zr or Ti catalyst, and of a main group metal hydrocarbyl functionality comprising aluminum (Al) as the metal for the second type of olefin monomer, since it is known that such a catalyst will not lead to chain transfer polymerization with an aluminum hydrocarbyl functionality. This means that the main group metal hydrocarbyl functionality of the second type of olefin monomer may preferably be inactive under the reaction conditions and/or with the catalyst used according to the present invention, meaning that it may preferably not negatively affect the catalytic activity and/or not lead to chain transfer processes. In the sense of the present invention, poisoning may thereby for example a poisoning that may reduce catalyst activity by at least 50%, preferably by at least 25%, further preferred by at least 20%, even further preferred by at least 15%, even further preferred by at least 10%, even further preferred by at least 5%, even further preferred by at least 3%, even further preferred by at least 1%, even further preferred by at least 0.5%. Moreover, chain transfer polymerization in the sense of the present invention may thereby for example be a chain transfer polymerization that accounts for at least 50%, preferably by at least 25%, further preferred by at least 20%, even further preferred by at least 15%, even further preferred by at least 10%, even further preferred by at least 5%, even further preferred by at least 3%, even further preferred by at least 1%, even further preferred by at least 0.5% of the polymer material produced by polymerization according to the process of the present invention.

This may preferably allow the formation of polymers with short chain branches by polymerizing the olefins of both comonomers with the catalyst used, but without chain transfer polymerization involving the main group metal hydrocarbyl functionality of the second type of olefin monomer. This may lead to a polymer backbone having pending main group metal hydrocarbyl functionalities, whereby there may be a spacer, like especially for example an alkyl group, between the backbone and the pending main group metal hydrocarbyl functionalities.

Metal catalyst as used in the present description may mean: a catalyst providing the catalytic reaction, wherein said catalyst comprises at least one metal center that forms the active site. In the context of the present invention a “metal catalyst” is the same as a “transition metal catalyst” wherein the metal is a transition metal.

Catalyst precursor as used in the present description may mean: a compound that upon activation forms the active catalyst.

Metallocene as used in the present description may mean: a metal catalyst or catalyst precursor typically consisting of two substituted cyclopentadienyl (Cp) ligands bound to a metal active site.

Half-metallocene as used in the present description may for example mean: a metal catalyst or catalyst precursor typically consisting of one substituted cyclopentadienyl (Cp) ligand bound to a metal active site.

Post-metallocene as used in the present description may mean especially for example: a metal catalyst that contains no substituted cyclopentadienyl (Cp) ligands, but may contains one or more anions bound to the metal active site, typically via a heteroatom.

Transition metal as used in the present description may mean: a metal from any of the Groups 3-10 of the IUPAC Periodic Table of elements or in other words a Group 3 metal, a Group 4 metal, a Group 5 metal, a Group 6 metal, a Group 7 metal, a Group 8 metal, a Group 9 metal or a Group 10 metal.

Co-catalyst as used in the present description may mean a compound that activates the catalyst precursor to obtain the active catalyst.

In an embodiment, the co-catalyst can be selected for example from the group consisting of MAO, DMAO, MMAO, SMAO, possibly in combination with aluminum alkyls, for example triisobutyl aluminum, and the combination of an aluminum alkyl, for example triisobutyl aluminum, and fluorinated aryl borane or fluorinated aryl borate.

In an embodiment, the scavenger can be selected for example from the group consisting of trialkyl aluminum, for example triisobutyl aluminum, MAO, DMAO, MMAO, SMAO.

Scavenger as used in the present description may mean a compound that scavenges impurities from the reaction medium prior and during the polymerization process. The co-catalyst thereby also function for example as scavenger.

Olefins Suitable for Use in Step A)

Examples of suitable monomers include linear or branched α-olefins. Said olefins preferably have between 2 and 30 carbon atoms, more preferably between 2 and 20 carbon atoms. Preferably, one or more of the following are used: ethylene, propylene, 1-butene, 4-methyl-1-pentene, 1-pentene, 1-hexene, 1-heptene, 1-octene, 1-nonene, 1-decene, 1-undecene, 1-dodecene, 1-tridecene, 1-tetradecene, 1-pentadecene, 1-hexadecene, 1-heptadecene, 1-octadecene, 1-cyclopentene, cyclohexene, norbornene, ethylidene-norbornene, and vinylidene-norbornene and one or more combinations thereof. In addition, a combination of ethylene and/or propylene on the one and one or more other olefins on the other hand is also possible. Substituted analogues of the monomers discussed above may also be used, e.g. substituted by one or more halogens. In addition aromatic monomers can be used according to the present invention. It is also possible to use a combination of two or more olefins.

Main Group Hydrocarbyl Functionality

The present invention uses at least one olefin monomer comprising a main group hydrocarbyl functionality. The present invention may for example also use said monomer in combination with other main group metal chain transfer agents, for example, zinc, and/or magnesium, and/or calcium, and/or, boron, and/or gallium, hydrocarbyl/hydride chain transfer agents.

The olefin monomer comprising a main group hydrocarbyl functionality used in the present invention has a structure according to Formula 1a:

R¹⁰⁰₍ₙ₋₂₎R¹⁰¹Mⁿ⁺R¹⁰² Formula 1a
wherein: M is a main group metal; n is the oxidation state of M; R¹⁰⁰, R¹⁰¹ and R¹⁰² are each independently selected from the group consisting of a hydride, a C1-C18 hydrocarbyl group, or a hydrocarbyl group Q on the proviso that at least one of R¹⁰⁰, R¹⁰¹ and R¹⁰² is hydrocarbyl group Q. Wherein hydrocarbyl group Q is according to Formula 1b:

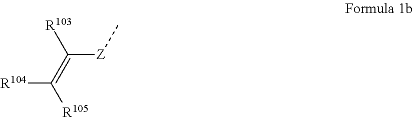

wherein Z is bonded to M and is a C1-C18 hydrocarbyl group; R¹⁰⁵ optionally forms a cyclic group with Z; wherein R¹⁰³ and R¹⁰⁴ and R¹⁰⁵ are each independently selected from hydrogen or hydrocarbyl;

In an embodiment, hydrocarbyl group Q is an α-olefin wherein Z is bonded to the main group metal, Z is a C1-C18 hydrocarbyl spacer group, R¹⁰³ and R¹⁰⁴ and R¹⁰⁵ are each hydrogen, said hydrocarbyl group Q being according to Formula 1c:

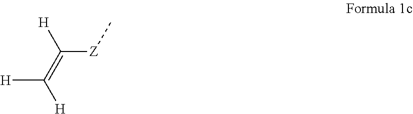

In an embodiment, hydrocarbyl group Q is an alkene wherein Z is bonded to the main group metal, Z is a C1-C18 hydrocarbyl spacer group, R¹⁰³ and R¹⁰⁴ are independently hydrogen or hydrocarbyl and R¹⁰⁵ is a C1-18 hydrocarbyl, said R¹⁰⁵ group forming a cyclic structure with Z, said hydrocarbyl group Q being according to Formula 1d:

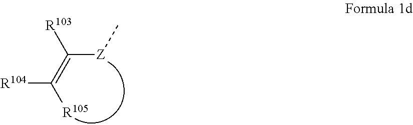

In an embodiment, said hydrocarbyl group Q can be an α-olefin according to Formula 1c or an unsaturated cyclic hydrocarbyl group according to Formula 1d. Preferably, hydrocarbyl group Q is an α-olefin or an unsaturated cyclic hydrocarbyl group.

Z is a branched or unbranched hydrocarbyl spacer group consisting of between 1 and 18 carbon atoms, preferably 2 and 8 carbon atoms, more preferably 4 and 7 carbon atoms, even more preferably 5 or 6 carbon atoms. Z is optionally substituted with hydrogen, carbon, heteroatoms.

In an embodiment, hydrocarbyl group Q is an α-olefin according to Formula 1c. Said α-olefin has up to and including 30 carbon atoms, such as up to and including 20 carbon atoms, preferably up to and including 10 carbon atoms, such as ethenyl, propenyl, butenyl, heptenyl, hexenyl, septenyl, octenyl, nonenyl or decenyl and can be unbranched or branched.

In a preferred embodiment, said α-olefin is an unbranched α-olefin according to Formula 1e. In other words, the aluminum hydrocarbyl functionality comprises at least one hydrocarbyl chain bearing an α-olefin (i.e. hydrocarbyl group Q). Said hydrocarbyl group Q is an α-olefin-comprising a main group metal.

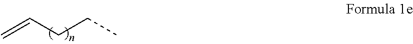

In a preferred embodiment, hydrocarbyl group Q is an α-olefin according to Formula 1e where n is 1-5. In other words, the hydrocarbyl group Q is 3-buten-1-yl, 4-penten-1-yl, 5-hexen-1-yl, 6-hepten-1-yl or 7-octen-1yl.

In an embodiment, the hydrocarbyl group Q is an unsaturated cyclic hydrocarbyl group according to Formula 1d. In said cyclic olefin the alkene is situated between substituents R¹⁰⁵ and Z and R¹⁰⁵ forms at least one ring with Z. R¹⁰⁵ can be a C1-C18 hydrocarbyl, which forms one or more bonds with Z to form a cyclic group.

The number of R groups around the main group metal is dependent on the oxidization state of the metal. For example, when the main group metal is zinc or magnesium or calcium, the oxidation state is +2, and the formula is R¹⁰⁰MR¹⁰¹.

For example, when the main group metal is aluminum or boron or gallium, the oxidation state is +3, and the formula is R¹⁰⁰R¹⁰¹MR¹⁰².

In a preferred embodiment, at least one olefin comprising a main group metal hydrocarbyl functionality can be for example ethyl(7-octen1-yl) zinc or bis(7-octen-1-yl) zinc.

In a preferred embodiment, an olefin comprising at least one main group metal hydrocarbyl functionality can for example be selected from one or more from the group of: di(isobutyl)(7-octen-1-yl) aluminum, di(isobutyl)(5-hexen-1-yl) aluminum, di(isobutyl)(3-buten-1-yl) aluminum, aluminum, tris(7-octen-1-yl) aluminum, tris(5-hexen-1-yl) aluminum and/or tris(3-buten-1-yl) aluminum.

In an embodiment, the copolymerization of at least one olefin comprising main group metal hydrocarbyl functionality and another α-olefin monomer may also for example be carried out in the presence of a chain transfer agent.

As non-limiting examples of chain transfer agents main group metal hydrocarbyl or hydride chain transfer agents such as for example the following be used: one or more hydrocarbyl or hydride groups attached to a main group metal selected from aluminum, magnesium, calcium, zinc, gallium or boron.

Catalyst System Suitable for Use in Step A)

A catalyst system for use in step a) comprises the at least or at least two of the following components:
i) a metal catalyst or metal catalyst precursor comprising a metal from Group 3-10 of the IUPAC Periodic Table of elements; and optionally at least one or more of
ii) a co-catalyst
iii) a scavenger
iv) a chain transfer agent and/or chain shuttling agent.

Suitable catalysts and/or catalyst precursors are discussed in this section as well as suitable co-catalysts and scavengers, which are optional.

A catalyst for step A) can be used without co-catalyst, a catalyst precursor for step A) requires a co-catalyst to obtain the actual active catalyst.

In the present invention, the catalyst may be thereby preferably be selected so that it does not lead to chain transfer polymerization with the main group metal hydrocarbyl functionality of the second type of olefin monomer.

An example of such a selection according to the present invention may thus for example be of a catalyst comprising zirconium (Zr) as the metal and a main group metal hydrocarbyl functionality comprising aluminum (Al) as the metal, since it is known that such a catalyst will not lead to chain transfer polymerization with this main group metal hydrocarbyl functionality of the second type of olefin monomer.

Accordingly, this may allow the formation of polymers with short chain branches by polymerizing the olefins of both comonomers with the catalyst used but without chain transfer polymerization involving the with the main group metal hydrocarbyl functionality of the second type of olefin monomer. This may preferably lead to a polymer backbone having pending main group metal hydrocarbyl functionalities, whereby there may be a spacer, like especially for example an alkyl group, between the backbone and the pending main group metal hydrocarbyl functionalities.

The catalyst may, however, lead to chain transfer polymerization with a chain transfer agent, such as for example hydrogen or silanes.

One or more scavenger that can be used for example to scavenge impurities from the reaction medium prior and during the polymerization process, can be selected for example from the group consisting of: trialkyl aluminum, especially for example triisobutyl aluminum, MAO, DMAO, MMAO, SMAO.

Metal catalyst and/or catalyst precursor suitable for step A) In the section below several examples for metal catalysts or metal catalyst precursors, which may be used to prepare the metal catalyst according to the present invention, are specified. Metal catalysts that are suitable for use in step A) of the present invention may be obtained by reaction the metal catalyst precursors with a co-catalyst either prior to use in step A) or by reaction in situ.

According to the present invention, the metal catalyst has a metal center selected from a Group 3 metal, a Group 4 metal, a Group 5 metal, a Group 6 metal, a Group 7 metal, a Group 8 metal, a Group 9 metal or a Group 10 metal, preferably Y, Sm, Ti, Zr, Hf, V, Cr, Fe, Co, Ni, Pd.

The metal catalysts or metal catalyst precursors may for example be Me₂Si(Ind)₂ZrCl₂, Me₂Si(2-Me-4-Ph-Ind)₂ZrCl₂, (C₅Me₅)₂Sm(THF)₂, [ortho-bis(2-indenyl)benzene] zirconium dichloride or [Me₂Si(C₅Me₄)N(tBu)]TiCl₂. THF being tetragydrofuran.

The metal catalyst or metal catalyst precursor can also be for example a preferably Cₛ or C₁ symmetric compound according to the formula (C₅R⁸₄)R⁹(C₁₃R⁸₈)ML¹ₙ, where C₅R⁸₄ is an unsubstituted or substituted cyclopentadienyl, and C13R¹¹8 is an unsubstituted fluorenyl group or a substituted fluorenyl group; and the bridging R⁹ group is selected from the group consisting of —Si(Me)₂-, —Si(Ph)₂-, —C(Me)₂- or —C(Ph)₂-, thus producing C₁- and Cₛ-symmetric metallocenes.

Non-limiting examples of zirconocene dichloride metal catalyst precursors suitable for use in the present invention include: bis(cyclopentadienyl) zirconium dichloride, bis(methyl-cyclopentadienyl) zirconium dichloride, bis(n-propyl-cyclopentadienyl) zirconium dichloride, bis(n-butyl-cyclopentadienyl) zirconium dichloride, bis(1,3-dimethyl-cyclopentadienyl) zirconium dichloride, bis(1,3-di-t-butyl-cyclopentadienyl) zirconium dichloride, bis(1,3-ditrimethylsilyl-cyclopentadienyl) zirconium dichloride, bis(1,2,4-trimethyl-cyclopentadienyl) zirconium dichloride, bis(1,2,3,4-tetramethyl-cyclopentadienyl) zirconium dichloride, bis(pentamethylcyclopentadienyl) zirconium dichloride, bis(indenyl) zirconium dichloride, bis(2-phenyl-indenyl) zirconium dichloride, bis(fluorenyl) zirconium dichloride, bis(tetrahydrofluorenyl) zirconium dichloride, dimethylsilyl-bis(cyclopentadienyl) zirconium dichloride, dimethylsilyl-bis(3-t-butyl-cyclopentadienyl) zirconium dichloride, dimethylsilyl-bis(3-trimethylsilyl-cyclopentadienyl) zirconium dichloride, dimethylsilyl-bis(tetrahydrofluorenyl) zirconium dichloride, dimethylsilyl-(1-indenyl)(cyclopentadienyl) zirconium dichloride, dimethylsilyl-(1-indenyl)(fluorenyl) zirconium dichloride, dimethylsilyl-(1-indenyl)(octahydrofluorenyl) zirconium dichloride, rac-dimethylsilyl-bis(2-methyl-3-t-butyl-cyclopentadienyl) zirconium dichloride, rac-dimethylsilyl-bis(1-indenyl) zirconium dichloride, rac-dimethylsilyl-bis(4,5,6,7-tetrahydro-1-indenyl) zirconium dichloride, rac-dimethylsilyl-bis(2-methyl-1-indenyl) zirconium dichloride, rac-dimethylsilyl-bis(4-phenyl-1-indenyl) zirconium dichloride, rac-dimethylsilyl-bis(2-methyl-4-phenyl-1-indenyl) zirconium dichloride, rac-ethylene-bis(1-indenyl) zirconium dichloride, rac-ethylene-bis(4,5,6,7-tetrahydro-1-indenyl) zirconium dichloride, rac-1,1,2,2-tetramethylsilanylene-bis(1-indenyl) zirconium dichloride, rac-1,1,2,2-tetramethylsilanylene-bis(4,5,6,7-tetrahydro-1-indenyl) zirconium dichloride, rac-ethylidene(1-indenyl)(2,3,4,5-tetramethyl-1-cyclopentadienyl) zirconium dichloride, rac-[1-(9-fluorenyl)-2-(2-methylbenzo[b]indeno[4,5-d]thiophen-1-yl)ethane]zirconium dichloride, dimethylsilyl bis(cyclopenta-phenanthren-3-ylidene) zirconium dichloride, dimethylsilyl bis(cyclopenta-phenanthren-1-ylidene) zirconium dichloride, dimethylsilyl bis(2-methyl-cyclopenta-phenanthren-1-ylidene) zirconium dichloride, dimethylsilyl bis(2-methyl-3-benz-inden-3-ylidene) zirconium dichloride, dimethylsilyl-bis[(3a,4,5,6,6a)-2,5-dimethyl-3-(2-methylphenyl)-6H-cyclopentathien-6-ylidene] zirconium dichloride, dimethylsilyl-(2,5-dimethyl-1-phenylcyclopenta[b]pyrrol-4(1H)-ylidene)(2-methyl-4-phenyl-1-indenyl) zirconium dichloride, bis(2-methyl-1-cyclopenta-phenanthren-1-yl)zirconium dichloride, [ortho-bis(4-phenyl-2-indenyl) benzene] zirconium dichloride, [ortho-bis(5-phenyl-2-indenyl) benzene] zirconium dichloride, [ortho-bis(2-indenyl)benzene] zirconium dichloride, [ortho-bis (1-methyl-2-indenyl)benzene] zirconium dichloride, [2,2′-(1,2-phenyldiyl)-1,I′dimethylsilyl-bis(indenyl)]zirconium dichloride, [2,2′-(1,2-phenyldiyl)-1,1′-(1,2-ethanediyl)-bis(indenyl)] zirconium dichloride, dimethylsilyl-(cyclopentadienyl)(9-fluorenyl) zirconium dichloride, diphenylsilyl-(cyclopentadienyl)(fluorenyl) zirconium dichloride, dimethylmethylene-(cyclopentadienyl)(fluorenyl) zirconium dichloride, diphenylmethylene-(cyclopentadienyl)(fluorenyl) zirconium dichloride, dimethylmethylene-(cyclopentadienyl)(octahydrofluorenyl) zirconium dichloride, diphenylmethylene-(cyclopentadienyl)(octahydrofluorenyl) zirconium dichloride, dimethylmethylene-(cyclopentadienyl)(2,7-di-t-butyl-fluorenyl) zirconium dichloride, diphenylmethylene-(cyclopentadienyl)(2,7-di-t-butyl-fluorenyl) zirconium dichloride, dimethylmethylene-(3-methyl-1-cyclopentadienyl)(fluorenyl) zirconium dichloride, diphenylmethylene-(3-methyl-1-cyclopentadienyl)(fluorenyl) zirconium dichloride, dimethylmethylene-(3-cyclohexyl-1-cyclopentadienyl)(fluorenyl) zirconium dichloride, diphenylmethylene-(3-cyclohexyl-1-cyclopentadienyl)(fluorenyl) zirconium dichloride, dimethylmethylene-(3-t-butyl-1-cyclopentadienyl)(fluorenyl) zirconium dichloride, diphenylmethylene-(3-t-butyl-1-cyclopentadienyl)(fluorenyl) zirconium dichloride, dimethylmethylene-(3-ademantyl-1-cyclopentadienyl)(fluorenyl) zirconium dichloride, diphenylmethylene-(3-ademantyl-1-cyclopentadienyl)(fluorenyl) zirconium dichloride, dimethylmethylene-(3-methyl-1-cyclopentadienyl)(2,7-di-t-butyl-fluorenyl) zirconium dichloride, diphenylmethylene-(3-methyl-1-cyclopentadienyl)(2,7-di-t-butyl-fluorenyl) zirconium dichloride, dimethylmethylene-(3-cyclohexyl-1-cyclopentadienyl)(2,7-di-t-butyl-fluorenyl) zirconium dichloride, diphenylmethylene-(3-cyclohexyl-1-cyclopentadienyl)(2,7-di-t-butyl-fluorenyl) zirconium dichloride, dimethylmethylene-(3-t-butyl-1-cyclopentadienyl)(2,7-di-t-butyl-fluorenyl) zirconium dichloride, diphenylmethylene-(3-t-butyl-1-cyclopentadienyl)(2,7-di-t-butyl-fluorenyl) zirconium dichloride, dimethylmethylene-(3-methyl-cyclopentadienyl)(octahydro-octamethyl-dibenzo-fluorenyl) zirconium dichloride, diphenylmethylene-(3-methyl-cyclopentadienyl)(octahydro-octamethyl-dibenzo-fluorenyl) zirconium dichloride, dimethylmethylene-(3-cyclohexyl-cyclopentadienyl)(octahydro-octamethyl-dibenzo-fluorenyl) zirconium dichloride, diphenylmethylene-(3-cyclohexyl-cyclopentadienyl)(octahydro-octamethyl-dibenzo-fluorenyl) zirconium dichloride, dimethylmethylene-(3-t-butyl-cyclopentadienyl)(octahydro-octamethyl-dibenzo-fluorenyl) zirconium dichloride, diphenylmethylene-(3-t-butyl-cyclopentadienyl)(octahydro-octamethyl-dibenzo-fluorenyl) zirconium dichloride, dimethylmethylene-(3-ademantyl-cyclopentadienyl)(octahydro-octamethyl-dibenzo-fluorenyl) zirconium dichloride, diphenylmethylene-(3-ademantyl-cyclopentadienyl)(octahydro-octamethyl-dibenzo-fluorenyl) zirconium dichloride.

Non-limiting examples of titanium dichloride metal catalyst precursors suitable for use in the present invention include: cyclopentadienyl(P,P,P-tri-t-butylphosphine imidato) titanium dichloride, pentafluorophenylcyclopentadienyl(P,P,P-tri-t-butylphosphine imidato) titanium dichloride, pentamethylcyclopentadienyl(P,P,P-tri-t-butylphosphine imidato) titanium dichloride, 1,2,3,4-tetraphenyl-cyclopentadienyl(P,P,P-tri-t-butylphosphine imidato) titanium dichloride, cyclopentadienyl(P,P,P-tricyclohexylphosphine imidato) titanium dichloride, pentafluorophenyl cyclopentadienyl(P,P,P-tricyclohexylphosphine imidato) titanium dichloride, pentamethylcyclopentadienyl(P,P,P-tricyclohexylphosphine imidato) titanium dichloride, 1,2,3,4-tetraphenyl-cyclopentadienyl(P,P,P-tricyclohexylphosphine imidato) titanium dichloride, pentamethylcyclopentadienyl(P,P-dicyclohexyl-P-(phenylmethyl)phosphine imidato) titanium dichloride, cyclopentadienyl(2,6-di-t-butyl-4-methylphenoxy) titanium dichloride, pentafluorophenylcyclopentadienyl(2,6-di-t-butyl-4-methylphenoxy) titanium dichloride, pentamethylcyclopentadienyl(2,6-di-t-butyl-4-methylphenoxy) titanium dichloride, 1,2,3-trimethyl-cyclopentadienyl(2,6-bis(1-methylethyl)phenolato) titanium dichloride, [(3a,4,5,6,6a-η)-2,3,4,5,6-pentamethyl-3aH-cyclopenta[b]thien-3a-yl](2,6-bis(1-methylethyl)phenolato) titanium dichloride, pentamethylcyclopentadienyl(N,N′-bis(1-methylethyl)ethanimidamidato) titanium dichloride, pentamethylcyclopentadienyl(N,N′-dicyclohexylbenzenecarboximidamidato) titanium dichloride, pentamethylcyclopentadienyl(N,N′-bis(1-methylethyl)benzenecarboximidamidato) titanium dichloride, cyclopentadienyl(1,3-bis(1,1-dimethylethyl)-2-imidazolidiniminato) titanium dichloride, cyclopentadienyl(1,3-dicyclohexyl-2-imidazolidiniminato) titanium dichloride, cyclopentadienyl(1,3-bis[2,6-bis(1-methylethyl)phenyl]-2-imidazolidiniminato) titanium dichloride, pentafluorophenylcyclopentadienyl(1,3-bis(1,1-dimethylethyl)-2-imidazolidiniminato) titanium dichloride, pentafluorophenylcyclopentadienyl(1,3-dicyclohexyl-2-imidazolidiniminato) titanium dichloride, pentafluorophenylcyclopentadienyl(1,3-bis[2,6-bis(1-methylethyl)phenyl]-2-imidazolidiniminato) titanium dichloride, pentamethylcyclopentadienyl(di-t-butylketimino) titanium dichloride, pentamethylcyclopentadienyl(2,2,4,4-tetramethyl-3-pentaniminato) titanium dichloride, [(3a,4,5,6,6a-η)-2,4,5,6-tetramethyl-3aH-cyclopenta[b]thien-3a-yl](2,2,4,4-tetramethyl-3-pentaniminato) titanium dichloride, cyclopentadienyl(N,N-bis(1-methylethyl)benzenecarboximidamidato) titanium dichloride, pentafluorophenylcyclopentadienyl(N,N-bis(1-methylethyl)benzenecarboximidamidato) titanium dichloride, pentamethylcyclopentadienyl(N,N-bis(1-methylethyl)benzenecarboximidamidato) titanium dichloride, cyclopentadienyl(2,6-difluoro-N,N-bis(1-methylethyl)benzenecarboximidamidato) titanium dichloride, pentafluorophenylcyclopentadienyl(2,6-difluoro-N,N-bis(1-methylethyl)benzenecarboximidamidato) titanium dichloride, pentamethylcyclopentadienyl(2,6-difluoro-N,N-bis(1-methylethyl)benzenecarboximidamidato) titanium dichloride, cyclopentadienyl(N,N-dicyclohexyl-2,6-difluorobenzenecarboximidamidato) titanium dichloride, pentafluorophenylcyclopentadienyl(N,N-dicyclohexyl-2,6-difluorobenzenecarboximidamidato) titanium dichloride, pentamethylcyclopentadienyl(N,N-dicyclohexyl-2,6-difluorobenzenecarboximidamidato) titanium dichloride, cyclopentadienyl(N,N,N′,N′-tetramethylguanidinato) titanium dichloride, pentafluorophenylcyclopentadienyl(N,N,N′,N′-tetramethylguanidinato) titanium dichloride, pentamethylcyclopentadienyl(N,N,N′,N′-tetramethylguanidinato) titanium dichloride, pentamethylcyclopentadienyl(1-(imino)phenylmethyl)piperidinato) titanium dichloride, pentamethylcyclopentadienyl chromium dichloride tetrahydrofuran complex.

A non-limiting list of examples of scandium catalysts that would be suitable for use in to the present invention are: (N-t-butylamido)(dimethyl)(tetramethylcyclopentadienyl)silane scandium bis(trimethylsilyl)methyl, (N-phenylamido)(dimethyl)(tetramethylcyclopentadienyl) silane scandium bis(trimethyl)methyl, (N-sec-butylamido)(dimethyl) (tetramethylcyclopentadienyl)silane scandium bis(trimethylsilyl)methyl, (N-sec-dodecylamido)(dimethyl)(fluorenyl)silane scandium hydride triphenylphosphine, (P-t-butylphospho)(dimethyl)(tetramethylcyclopentadienyl) silane scandium bis(trimethylsilyl)methyl. Other examples are the catalysts cited in the list directly above wherein L¹ is hydride, methyl, benzyl, phenyl, allyl, (2-N,N-dimethylaminomethyl)phenyl, (2-N,N-dimethylamino)benzyl; in other words scandium methyl, scandium benzyl, scandium allyl, scandium (2-N,N-dimethylamino)benzyl; and/or wherein the metal is trivalent yttrium or samarium; Other examples are metal catalyst precursors as cited in the list directly above wherein Lₙ is chloride, bromide, hydride, methyl, benzyl, phenyl, allyl, (2-N,N-dimethylaminomethyl)phenyl, (2-N,N-dimethylamino)benzyl and/or wherein the metal is trivalent titanium or trivalent chromium.

Non-limiting examples of titanium(IV) dichloride metal catalyst suitable for use in the present invention are: (N-t-butylamido)(dimethyl)(tetramethylcyclopentadienyl)silane titanium dichloride, (N-phenylamido)(dimethyl)(tetramethylcyclopentadienyl) silane titanium dichloride, (N-sec-butylamido)(dimethyl)(tetramethylcyclopentadienyl)silane titanium dichloride, (N-sec-dodecylamido)(dimethyl)(fluorenyl)silane titanium dichloride, (3-phenylcyclopentadien-1-yl) dimethyl(t-butylamido) silane titanium dichloride, (3-(pyrrol-1-yl)cyclopentadien-1-yl) dimethyl(t-butylamido)silane titanium dichloride, (3,4-diphenylcyclopentadien-1-yl)dimethyl(t-butylamido) silane titanium dichloride, 3-(3-N,N-dimethylamino)phenyl) cyclopentadien-1-yl)dimethyl(t-butylamido) silane titanium dichloride, (P-t-butylphospho)(dimethyl) (tetramethylcyclopentadienyl) silane titanium dichloride. Other examples are the metal catalyst precursor cited in the list directly above wherein Lₙ is dimethyl, dibenzyl, diphenyl, 1,4-diphenyl-2-butene-1,4-diyl, 1,4-dimethyl-2-butene-1,4-diyl or 2,3-dimethyl-2-butene-1,4-diyl; and/or wherein the metal is zirconium or hafnium

Suitable metal catalyst precursors can be also the trivalent transition metal as those described in WO 9319104 (for example see especially example 1, page 13, line 15).

Suitable metal catalyst precursors can be also the trivalent transition metal as [C₅Me₄CH₂CH₂N(n-Bu)₂]TiCl₂ described in WO 9613529 (for example see especially example III, page 20, line 10-13) or [C₅H(iPr)₃CH₂CH₂NMe₂]TiCl₂ described in WO 97142232 and WO 9742236 (for example see especially example 1, page 26, line 14).

In an embodiment, the metal catalyst precursor is [C₅H₄CH₂CH₂NMe₂]TiCl₂;

In an embodiment, the metal catalyst or metal catalyst precursor may also be [C₅Me₄CH₂CH₂NMe₂]TiCl₂, [C₅H₄CH₂CH₂NiPr₂]TiCl₂, [C₅Me₄CH₂CH₂NiPr₂]TiCl₂, [C₅H₄C₉H₆N]TiCl₂, [C₅H₄CH₂CH₂NMe₂]CrCl₂, [C₅Me₄CH₂CH₂NMe₂]CrCl₂; [C₅H₄CH₂CH₂NiPr₂]CrCl₂, [C₅Me₄CH₂CH₂NiPr₂]CrCl₂ or [C₅H₄C₉H₆N]CrCl₂.

A non-limiting list of examples of metal catalyst precursors that would be suitable according to the present invention are: (N,N-dimethylamino)methyl-tetramethylcyclopentadienyl titanium dichloride, (N,N-dimethylamino)ethyl-tetramethylcyclopentadienyl titanium dichloride, (N,N-dimethylamino)propyl-tetramethylcyclopentadienyl titanium dichloride, (N,N-dibuthylamino)ethyl-tetramethylcyclopentadienyl titanium dichloride, (pyrrolidinyl)ethyl-tetramethylcyclopentadienyl titanium dichloride, (N,N-dimethylamino)ethyl-fluorenyl titanium dichloride, (bis(1-methyl-ethyl)phosphino)ethyl-tetramethylcyclopentadienyl titanium dichloride, (bis(2-methyl-propyl)phosphino)ethyl-tetramethylcyclopentadienyl titanium dichloride, (diphenylphosphino)ethyl-tetramethylcyclopentadienyl titanium dichloride, (diphenylphosphino)methyldimethylsilyl-tetramethylcyclopentadienyl titanium dichloride. Other examples are the catalysts cited in the list directly above wherein Lₙ is bromide, hydride, methyl, benzyl, phenyl, allyl, (2-N,N-dimethylaminomethyl)phenyl, (2-N,N-dimethylamino)benzyl, 2,6-dimethoxyphenyl, pentafluorophenyl, and/or wherein the metal is trivalent titanium or trivalent chromium.

The metal catalysts or metal catalyst precursors for use in the present invention may also be from post-metallocene catalysts or catalyst precursors.

In a preferred embodiment, the metal catalyst or metal catalyst precursor may be: [HN(CH₂CH₂N-2,4,6-Mea-C₆H₂)₂]Hf(CH₂Ph)₂ or bis[N,N′-(2,4,6-trimethylphenyl)amido)ethylenediamine]hafnium dibenzyl.

In a another preferred embodiment, the metal catalyst or metal catalyst precursor may be 2,6-diisopropylphenyl-N-(2-methyl-3-(octylimino)butan-2) hafnium trimethyl, 2,4,6-trimethylphenyl-N-(2-methyl-3-(octylimino)butan-2) hafnium trimethyl.

In a preferred embodiment, the metal catalyst or metal catalyst precursor may be [2,6-iPr₂C₆H₃NC(2-iPr-C₆H₄)-2-(6-C₅H₆)]HfMe₂-[N-(2,6-di(I-methylethyl)phenyl)amido)(2-isopropylphenyl) (α-naphthalen-2-diyl(6-pyridin-2-diyl)methane)]hafnium dimethyl.

Other non-limiting examples of metal catalyst precursors according to the present invention are: [N-(2,6-di(1-methylethyl)phenyl)amido)(o-tolyl)(α-naphthalen-2-diyl(6-pyridin-2-diyl)methane)] hafnium dimethyl, [N-(2,6-di(1-methylethyl)phenyl)amido)(o-tolyl)(α,α-naphthalen-2-diyl(6-pyridin-2-diyl)methane)] hafnium di(N,N-dimethylamido), [N-(2,6-di(I-methylethyl)phenyl)amido)(o-tolyl)(α,α-naphthalen-2-diyl(6-pyridin-2-diyl)methane)] hafnium dichloride, [N-(2,6-di(1-methylethyl)phenyl)amido)(phenanthren-5-yl)(α,α-naphthalen-2-diyl (6-pyridin-2-diyl)methane)] hafnium dimethyl, [N-(2,6-di(1-methylethyl)phenyl)amido)(phenanthren-5-yl)(α-naphthalen-2-diyl(6-pyridin 2-diyl)methane)] hafnium di(N,N-dimethylamido), [N-(2,6-di(I-methylethyl)phenyl)amido)(phenanthren-5-yl) (α-naphthalen-2-diyl(6-pyridin-2-diyl)methane)]hafnium dichloride. Other non-limiting examples include the family of pyridyl diamide metal dichloride complexes such as: [N-[2,6-bis(1-methylethyl)phenyl]-6-[2-[phenyl(phenylamino-κN)methyl]phenyl]-2-pyridinemethanaminato(2-)-κN¹,κN²]hafnium dichloride, [N-[2,6-bis(1-methylethyl)phenyl]-6-[2-[(phenylamino-κN)methyl]-1-naphthalenyl]-2-pyridinemethanaminato(2-)-κN¹,κN²] hafnium dichloride, [N-[2,6-bis(1-methylethyl)phenyl]-α-[2-(1-methylethyl)phenyl]-6-[2-[(phenylamino-κN)methyl]phenyl]-2-pyridinemethanaminato(2-)-κN¹,κN²]zirconium dichloride, [N-(2,6-diethylphenyl)-6-[2-[phenyl(phenylamino-κN)methyl]-1-naphthalenyl]-2-pyridinemethanaminato(2+κN¹,κN²]zirconium dichloride, [4-methyl-2-[[2-phenyl-1-(2-pyridinyl-κN)ethyl]amino-κN]phenolato(2-)-κO]bis(phenylmethyl)hafnium bis(phenylmethyl), [2-(1,1-dimethylethyl)-4-methyl-6-[[2-phenyl-1-(2-pyridinyl-κN) ethyl]amino-κN]phenolato(2-)-κO] hafnium bis(phenylmethyl), [2-(1,1-dimethylethyl)-4-methyl-6-[[phenyl(2-pyridinyl-κN)methyl]amino-κN]phenolato(2-)-κO]hafnium bis(phenylmethyl).

In a preferred embodiment, the catalyst precursor is: [2-(2,4,6-iPr₃-C₆H₂)-6-(2,4,6-iPr₃-C₆H₂)—C₅H₃N]Ti(CH₂Ph)₃ or [Et₂NC(N-2,6-iPr₂-C₆H₃)₂]TiCl₃

Other non-limiting examples of metal catalyst precursors according to the present invention are: {N′,N″-bis[2,6-di(1-methylethyl)phenyl]-N,N-diethylguanidinato}titanium trichloride, {N′,N″bis[2,6-di(1-methylethyl)phenyl]-N-methyl-N-cyclohexylguanidinato}titanium trichloride, {N′,N″-bis[2,6-di(1-methylethyl)phenyl]-N,N-pentamethyleneguanidinato} titanium trichloride, {N′,N″-bis[2,6-di(methyl)phenyl]-sec-butyl-aminidinato} titanium trichloride, {N-trimethylsilyl,N′—(N″,N″-dimethylaminomethyl)benzamidinato} titanium dichloride THF complex, {N-trimethylsilyl,N′—(N″,N″-dimethylaminomethyl)benzamidinato} vanadium dichloride THF complex, {N,N′-bis(trimethylsilyl)benzamidinato} titanium dichloride THF complex, {N,N′-bis(trimethylsilyl)benzamidinato} vanadium dichloride THF complex.

Non-limiting examples of metal catalyst precursors according to the present invention according are: N,N′-1,2-acenaphthylenediylidenebis(2,6-bis(1-methylethyl)benzenamine) nickel dibromide, N,N′-1,2-ethanediylidenebis(2,6-dimethylbenzenamine) nickel dibromide, N,N′-1,2-ethanediylidenebis(2,6-bis(1-methyl-ethyl)benzenamine) nickel dibromide, N,N′-1,2-acenaphthylenediylidenebis(2,6-dimethylbenzenamine) nickel dibromide, N,N′-1,2-acenaphthylenediylidenebis(2,6-bis(1-methylethyl)benzenamine) nickel dibromide, N,N′-1,2-acenaphthylenediylidenebis(1,1′-biphenyl)-2-amine nickel dibromide. Other examples are the catalysts cited in the list directly above wherein bromide can be replaced with chloride, hydride, methyl, benzyl and/or the metal can be palladium.

In a preferred embodiment, the catalyst precursor can be for example: [C₅H₃N{CMe=N(2,6-iPr₂C₆H₃)}₂]FeCl₂, [2,4-(t-Bu)_{2,-6}-(CH═NC₆F₅)C₆H₂O]₂TiCl₂ or bis[2-(1,1-dimethylethyl)-6-[(pentafluorophenylimino)methyl] phenolato] titanium dichloride. Other non-limiting examples of metal catalyst precursors according to the present invention can be for example: bis[2-[(2-pyridinylimino)methyl]phenolato] titanium dichloride, bis[2-(1,1-dimethylethyl)-6-[(phenylimino)methyl]phenolato] titanium dichloride, bis[2-(1,1-dimethylethyl)-6-[(1-naphthalenylimino)methyl]phenolato] titanium dichloride, bis[3-[(phenylimino)methyl][1,1-biphenyl]-2-phenolato] titanium dichloride, bis[2-(1,1-dimethylethyl)-4-methoxy-6-[(phenylimino)methyl]phenolato] titanium dichloride, bis[2,4-bis(1-methyl-1-phenylethyl)-6-[(phenylimino)methyl]phenolato] titanium dichloride, bis[2,4-bis(1,1-dimethylpropyl)-6-[(phenylimino)methyl]phenolato] titanium dichloride, bis[3-(1,1-dimethylethyl)-5-[(phenylimino)methyl][1,1′-biphenyl]-4-phenolato] titanium dichloride, bis[2-[(cyclohexylimino)methyl]-6-(1,1-dimethylethyl)phenolato] titanium dichloride, bis[2-(1,1-dimethylethyl)-6-[[[2-(1-methylethyl)phenyl]imino]methyl]phenolato] titanium dichloride, bis[2-(1,1-dimethylethyl)-6-[(pentafluorophenylimino)ethyl]phenolato] titanium dichloride, bis[2-(1,1-dimethylethyl)-6-[(pentafluorophenylimino)propyl]phenolato] titanium dichloride, bis[2,4-bis(1,1-dimethylethyl)-6-[1-(phenylimino)ethyl]phenolato] titanium dichloride, bis[2,4-bis(1,1-dimethylethyl)-6-[1-(phenylimino)propyl]phenolato] titanium dichloride, bis[2,4-bis(1,1-dimethylethyl)-6-[phenyl(phenylimino)methyl]phenolato] titanium dichloride. Other examples are the metal catalyst precursor cited in the list directly above wherein the dichloride can be replaced with dimethyl, dibenzyl, diphenyl, 1,4-diphenyl-2-butene-1,4-diyl, 1,4-dimethyl-2-butene-1,4-diyl or 2,3-dimethyl-2-butene-1,4-diyl; and/or wherein the metal is zirconium or hafnium. In other words, the hafnium dichloride, zirconium dichloride, titanium dimethyl, zirconium dimethyl, hafnium dimethyl, titanium dibenzyl, zirconium dibenzyl, hafnium dibenzyl, titanium diphenyl, zirconium diphenyl, hafnium diphenyl, titanium 1,4-dimethyl-2-butene-1,4-diyl, zirconium 1,4-dimethyl-2-butene-1,4-diyl, hafnium 1,4-dimethyl-2-butene-1,4-diyl, titanium 2,3-dimethyl-2-butene-1,4-diyl, zirconium 2,3-dimethyl-2-butene-1,4-diyl or hafnium 2,3-dimethyl-2-butene-1,4-diyl variants of the titanium dichloride metal catalyst precursor cited in the list directly above, [2-[[[2,6-bis(1-methylethyl)phenyl] imino-κN]methyl]-6-(1,1-dimethylethyl)phenolato-κO] nickel phenyl(triphenylphosphine), [2-[[[2,6-bis(1-methylethyl)phenyl]imino-κN]methyl]-6-(1,1-dimethylethyl) phenolato-κO] nickel phenyl(triphenylphosphine), [2-[[[2,6-bis(1-methylethyl)phenyl] imino-κN]methyl]phenolato-κO] nickel phenyl(triphenylphosphine)-, [3-[[[2,6-bis(1-methylethyl)phenyl]imino-κN]methyl][1,1′-biphenyl]-2-olato-κO] nickel phenyl(triphenylphosphine)-, [2-[[[2,6-bis(1-methylethyl)phenyl]imino-κN]methyl]-4-methoxyphenolato-κO] nickel phenyl(triphenylphosphine), [2-[[[2,6-bis(1-methylethyl) phenyl]imino-κN]methyl]-4-nitrophenolato-κO] nickel phenyl(triphenylphosphine), [2,4-diiodo-6-[[[3,3″,5,5″-tetrakis(trifluoromethyl)[1,1:3′,1″-terphenyl]-2′-yl]imino-κN] methyl]phenolato-κO] nickel methyl[[3,3′,3″-(phosphinidyne-κP)tris[benzenesulfonato] ]] trisodium; [2,4-diiodo-6-[[[3,3″,5,5″-tetrakis(trifluoromethyl)[1,1′:3′,1″-terphenyl]-2′-yl]imino-κN]methyl]phenolato-κO] nickel methyl[[3,3′-(phenylphosphinidene-κP) bis[benzenesulfonato]]]-disodium.

In a preferred embodiment, the catalyst precursor can be: [2-[[[2-[[[3,5-bis(1,1-dimethylethyl)-2-(hydroxy-κO)phenyl]methyl]amino-κN]ethyl]methylamino-κN]methyl]-4,6-bis(1,1-dimethylethyl)phenolato(2-)-κO] titanium bis(phenylmethyl), [2,4-dichloro-6-[[[2-[[[3,5-dichloro-2-(hydroxy-κO)phenyl]methyl]amino-κN]ethyl]methylamino-κN] methyl]phenolato(2-)-κO] titanium bis(phenylmethyl), [2-[[[[1-[[2-(hydroxy-κO)-3,5-diiodophenyl]methyl]-2-pyrrolidinyl-κN]methyl]amino-κN]methyl]-4-methyl-6-tricyclo[3.3.1.1^{3,7}]dec-1-ylphenolato(2-)-κO] titanium bis(phenylmethyl), [2-[[[2-[[[[2-(hydroxy-κO)-3,5-bis(1-methyl-1-phenylethyl)phenyl]methyl]methylamino-κN]methyl] phenyl]methylamino-κN]methyl]-4,6-bis(1-methyl-1-phenylethyl)phenolato(2-)-κO] titanium bis(phenylmethyl), [2,4-dichloro-6-[[[2-[[[[3,5-dichloro-2-(hydroxy-κO)phenyl] methyl]amino-κN]methyl]phenyl]amino-κN]methyl]phenolato(2-)-κO] titanium bis(phenylmethyl). Other examples are the metal catalyst precursor cited in the list directly above wherein bis(phenylmethyl) can be replaced with dichloride, dimethyl, diphenyl, 1,4-diphenyl-2-butene-1,4-diyl, 1,4-dimethyl-2-butene-1,4-diyl or 2,3-dimethyl-2-butene-1,4-diyl; and/or wherein the metal is zirconium or hafnium.

In a preferred embodiment, the metal catalyst or metal catalyst precursor can be for example: [[2,2′-[[[2-(dimethylamino-κN)ethyl]imino-κN]bis(methylene)]bis[4,6-bis(1,1-dimethylethyl) phenolato-κO]] zirconium dibenzyl, (phenylmethyl)[[2,2′-[(propylimino-κN)bis(methylene)]bis[4,6-bis(1,1-dimethylethyl)phenolato-κO]] zirconium dibenzyl or (phenylmethyl)[[2,2′-[[[(2-pyridinyl-κN)methyl]imino-κN]bis(methylene)]bis[4,6-bis(1,1-dimethylethyl)phenolato-κO]] zirconium dibenzyl.

In a preferred embodiment, complexes as reported in WO 00/43426, WO 2004/081064, US 2014/0039138 A1, US 2014/0039139 A1 and US 2014/0039140 A1 are suitable to use as metal catalyst precursors for the processes of the present invention.

Co-Catalyst Suitable for Step A)

A co-catalyst can be used when a metal catalyst precursor is applied. The function of this co-catalyst is to activate the metal catalyst precursor. Co-catalysts may be selected for example from the group consisting of MAO, DMAO, MMAO, SMAO, possibly in combination with aluminum alkyls, for example triisobutyl aluminum, and/or with a combination of an aluminum alkyl, for example triisobutyl aluminum, and a fluorinated aryl borane or fluorinated aryl borate (viz. B(R′)_{y} wherein R′ is a fluorinated aryl and y is 3 or 4, respectively). Examples of a fluorinated borane is B(C₆F₅)₃ and of fluorinated borates are [X]⁺[B(C₆F₅)_{4]}⁻ (e.g. X=Ph₃C, C₆H₅N(H)Me₂).

Methylaluminoxane or MAO as used in the present description may mean: a compound derived from the partial hydrolysis of trimethyl aluminum that serves as a co-catalyst for catalytic olefin polymerization.

Supported methylaluminoxane or SMAO as used in the present description may mean: a methylaluminoxane bound to a solid support.

Depleted methylaluminoxane or DMAO as used in the present description may mean: a methylaluminoxane from which the free trimethyl aluminum has been removed.

Modified methylaluminoxane or MMAO as used in the present description may mean: modified methylaluminoxane, viz. the product obtained after partial hydrolysis of trimethyl aluminum plus another trialkyl aluminum such as tri(isobutyl) aluminum or tri-n-octyl aluminum.

Fluorinated aryl borates or fluorinated aryl boranes as used in the present description may mean: a borate compound having three or four fluorinated (preferably perfluorinated) aryl ligands or a borane compound having three fluorinated (preferably perfluorinated) aryl ligands.

For example, the co-catalyst can be an organometallic compound. The metal of the organometallic compound can be selected from Group 1, 2, 12 or 13 of the IUPAC Periodic Table of Elements. Preferably, the co-catalyst is an organoaluminum compound, more preferably an aluminoxane, said aluminoxane being generated by the reaction of a trialkyl aluminum compound with water to partially hydrolyze said aluminoxane. For example, trimethyl aluminum can react with water (partial hydrolysis) to form methylaluminoxane (MAO). MAO has the general formula (Al(CH₃)₃₋ₙO_{0.5n})ₓ.(AlMe₃)_{y} having an aluminum oxide framework with methyl groups on the aluminum atoms.

MAO generally contains significant quantities of free trimethyl aluminum (TMA), which can be removed by drying the MAO to afford the so-called depleted MAO or DMAO. Supported MAO (SMAO) may also be used and may be generated by the treatment of an inorganic support material, typically silica, by MAO.

Alternatively to drying the MAO, when it is desired to remove the free trimethyl aluminum, butylhydroxytoluene (BHT, 2,6-di-t-butyl-4-methylphenol) can be added which reacts with the free trimethyl aluminum.

Neutral Lewis acid modified polymeric or oligomeric aluminoxanes may also be used, such as alkylaluminoxanes modified by addition of a C1-30 hydrocarbyl substituted Group 13 compound, especially a tri(hydrocarbyl) aluminum- or tri(hydrocarbyl) boron compounds, or a halogenated (including perhalogenated) derivatives thereof, having 1 to 10 carbons in each hydrocarbyl or halogenated hydrocarbyl group, more especially a trialkyl aluminum compound.

Other examples of polymeric or oligomeric aluminoxanes are tri(isobutyl) aluminum- or tri(n-octyl) aluminum-modified methylaluminoxane, generally referred to as modified methylaluminoxane, or MMAO. In the present invention, MAO, DMAO, SMAO and MMAO may all be used as co-catalyst.

In addition, for certain embodiments, the metal catalyst precursors may also be rendered catalytically active by a combination of an alkylating agent and a cation forming agent which together form the co-catalyst, or only a cation forming agent in the case the catalyst precursor is already alkylated, as exemplified in T. J. Marks et al., Chem. Rev. 2000, (100), 1391. Suitable alkylating agents are trialkyl aluminum compounds, preferably TIBA. Suitable cation forming agents for use herein include (i) neutral Lewis acids, such as 01-30 hydrocarbyl substituted Group 13 compounds, preferably tri(hydrocarbyl)boron compounds and halogenated (including perhalogenated) derivatives thereof, having from 1 to 10 carbons in each hydrocarbyl or halogenated hydrocarbyl group, more preferably perfluorinated tri(aryl)boron compounds, and most preferably tris(pentafluorophenyl) borane, (ii) non polymeric, compatible, non-coordinating, ion forming compounds of the type [C]⁺[A]⁻ where “C” is a cationic group such as ammonium, phosphonium, oxonium, carbonium, silylium or sulfonium groups and [A]⁻ is an anion, especially for example a borate.

Non-limiting examples of the anionic [“A”] are borate compounds such as C1-30 hydrocarbyl substituted borate compounds, preferably tetra(hydrocarbyl)boron compounds and halogenated (including perhalogenated) derivatives thereof, having from 1 to 10 carbons in each hydrocarbyl or halogenated hydrocarbyl group, more preferably perfluorinated tetra(aryl)boron compounds, and most preferably tetrakis(pentafluorophenyl) borate.

A supported catalyst may also be used, for example using SMAO as the co-catalyst or other supports for the catalyst. The support material can be an inorganic material. Suitable supports include solid and particulated high surface area, metal oxides, metalloid oxides, or mixtures thereof. Examples include: talc, silica, alumina, magnesia, titania, zirconia, tin oxide, aluminosilicates, borosilicates, clays, and mixtures thereof.

Preparation of a supported catalyst can be carried out using methods known in the art, for example i) a metal catalyst precursor can be reacted with supported MAO to produce a supported catalyst; ii) MAO can be reacted with a metal catalyst precursor and the resultant mixture can be added to silica to form the supported catalyst; iii) a metal catalyst precursor immobilized on a support can be reacted with soluble MAO.

Copolymerization of an Olefin and an Olefin Comprising a Main Metal Hydrocarbyl Functionality

Step A) is preferably carried out in an inert atmosphere.

Copolymerization of the olefins can for example be carried out in the gas phase below the melting point of the polymer. Copolymerization can also be carried out in the slurry phase below the melting point of the polymer. Moreover, copolymerization can be carried out in solution at temperatures above the melting point of the polymer product.

It is known to continuously polymerize one or more olefins, such as ethylene or propylene, in solution or in slurry, e.g. in a continuous (multi) CSTR or (multi) loop reactor, in the gas-phase in a reactor with a fluidized or mechanically stirred bed or in a combination of these different reactors, in the presence of a catalyst based on a compound of a transition metal belonging to Groups 3 to 10 of the Periodic Table of the Elements.

Slurry phase polymerizations are typically carried out at temperatures in the range 50-125° C. and at pressures in the range 1-40 bar.

The present invention may also be carried out in a solution polymerization process. Typically, in the solution process, the monomer and polymer are dissolved in an inert solvent.

Although a single reactor can be used, multiple reactors provide a narrower residence time distribution and therefore a better control of molecular weight distribution.

Step B) Oxidation

A second step of the process according to the present invention can be step B) and relates to contacting the polyolefin obtained in step A) with at least one oxidizing agent or safe oxidizing agent to obtain to obtain a polyolefin having one or more pending polar and/or nucleophilic functionalities. Step B) can, however, be optional, especially for example if a halogen or a halogen containing compound is used as a quenching agent.

Typically the functionalization consists of an oxidation step followed by a subsequent quenching step to release the main group metal from the oxidized polyolefin chain (this can be for example by a hydrolysis step in water). In this way, branched polyolefins bearing pending polar functionalities and/or branch end-group functions, such as especially for example alcohol functions or carboxylic acid functions, can be obtained.

A quenching agent as used in the present description may mean: an agent to remove the main group metal from the polyolefin having one or multiple main group metal end-functionalized oxidized branches to obtain end-group functions and/or pending functions.

As safe oxidizing agent in step B) the following may for example be used: CO, CO₂, CS₂, COS, R²NCO, R²NCS, R²NCNR³, CH₂═C(R²)C(═O)OR³, CH₂═C(R²)(C═O)N(R³)R⁴, CH₂═C(R²)P(═O)(OR³)OR⁴, N₂O, R²CN, R²NC, epoxide, aziridine, cyclic anhydride, R³R⁴C═NR², carbodiimides, R²C(═O)R³, ClC(═O)OR² and SO₃, preferably N₂O, CO₂ and SO₃.

In an embodiment, an oxidizing agent or safe oxidizing agent used in the present invention can be dried. A dried safe oxidizing agent according to the invention can thereby preferably comprise less than 100 ppm of water, preferably less than 50 ppm of water, further preferred less than 20 ppm of water, even more preferred less than 10 ppm of water, even more preferred less than 5 ppm of water, even more preferred less than 3 ppm of water. This can contribute to improve oxidation yield, especially when using a safe oxidizing agent.

According to the present invention, content of comonomer can represent for example at between 0.01 mol-% and 70 mol-%, preferably between 0.05 mol-% and 30 mol-%, preferably between 0.06 mol-% and 20 mol-%, preferably between 0.07 mol-% and 15 mol-%, preferably between 0.08 mol-% and 10 mol-%, preferably between 0.09 mol-% and 8 mol-%, preferably between 0.1 mol-% and 7 mol-%, further preferred between 0.5 mol-% and 5 mol-%, further preferred between 1 mol-% and 4 mol-%, further preferred between 2 mol-% and 3 mol-% and/or at least 0.001 mol-%, further preferred least 0.01 mol-%, preferably 0.1 mol-%, further preferred 0.5 mol-%, further preferred at least 1 mol-%, preferred at least 10 mol-%, further preferred at least 15 mol-%, further preferred at least 20 mol-%, further preferred at least 30 mol-%, further preferred at least 40 mol-%, further preferred at least 50 mol-%, further preferred at least 60 mol-% of the obtained polymers.

Similarly, content of polar functionalities, can represent for example at between 0.01 mol-% and 60 mol-%, preferably between 0.05 mol-% and 25 mol-%, preferably preferably between 0.07 mol-% and 15 mol-%, preferably between 0.08 mol-% and 8 mol-%, preferably between 0.01 mol-% and 7 mol-%, preferably between 0.1 mol-% and 5 mol-%, further preferred between 0.5 mol-% and 4.5 mol-%, further preferred between 1 mol-% and 4 mol-%, further preferred between 2 mol-% and 3 mol-%, further preferred between 1.5 mol-% and 2.5 mol-% and/or at least 0.001 mol-%, further preferred least 0.01 mol-%, preferably 0.1 mol-%, further preferred 0.5 mol-%, further preferred at least 1 mol-%, preferred at least 10 mol-%, further preferred at least 15 mol-%, further preferred at least 20 mol-%, further preferred at least 30 mol-%, further preferred at least 40 mol-%, further preferred at least 50 mol-%, further preferred at least 60 mol-% of the obtained polymers.

A polymer with a relatively low content of polar functions and/or of comonomer can thereby for example ensure and be used to provide a good miscibility with polyolefins, while still contributing to improve compatibility with more polar materials. On the other hand, a relatively high content of polar functionalities and/or of comonomer can for example contribute to improve compatibility with polar materials, other materials and/or barrier properties.

With respect to CO, after quenching for example an aldehyde or ketone functionalized branched polyolefin (Pol-C(═O)H or Pol-C(═O)R¹) can be obtained.

With respect to R²NC, after quenching for example either (Pol-C(═NR²)H or Pol-C(═NR²)R¹) can be obtained.

With respect to CO₂, after quenching for example either an acid or ester functionalized branched polyolefin (Pol-C(═O)OH or Pol-C(═O)OR¹) can be obtained.

With respect to CS₂, after quenching for example either Pol-C(═S)SH or Pol-C(═S)SR¹ can be obtained.

With respect to COS, after quenching for example either Pol-C(═O)SH, Pol-C(═S)OH, Pol-C(═O)SR¹ or Pol-C(═S)OR¹) can be obtained.

With respect to R²NCO, after quenching for example amide or imino functionalized branched polyolefin (Pol-C(═O)NR²H, Pol-C(═NR²)OH, Pol-C(═O)NR²R¹ or Pol-C(═NR²)OR¹) can be obtained.

With respect to R²NCS, after quenching for example thiomidic acid, thioamide or thioamidate (ester) functionalized branched polyolefin (Pol-C(═S)NR²H, Pol-C(═NR²)SH, Pol-C(═S)NR²R¹ or Pol-C(═NR²)SR¹) can be obtained.

With respect to R²NCNR³, after quenching for example an amide functionalized branched polyolefin (Pol-C(═NR²)NR³R¹) can be obtained.

With respect to CH₂═CR²COOR³, after quenching for example either a hemiacetal or acetal functionalized branched polyolefin (Pol-CH₂CR²═C(OR³)OH or Pol-CH₂CR²═C(OR³)OR¹) can be obtained.

With respect to CH₂═C(R²)C(═O)NR³R⁴, after quenching for example a functionalized branched polyolefin of formula Pol-CH₂—C(R²)═C(NR³R⁴)OR¹ can be obtained.

With respect to CH₂═C(R²)P(═O)(OR³)OR⁴, after quenching for example a functionalized branched polyolefin of formula Pol-CH₂—C(R²)═P(OR³)(OR⁴)OR¹ can be obtained.

With respect to N₂O, the metal carbon bond is cleaved and oxygen is inserted to form a Pol-O-M. After quenching for example either an alcohol or an ether functionalized branched polyolefin (Pol-OH or Pol-OR¹) can be obtained.

With respect to R²CN, after quenching for example either a substituted or non-substituted imine functionalized branched polyolefin (Pol-C(R²)═NR¹ or Pol-C(R²)═NH) can be obtained.

With respect to epoxide, after quenching for example an alcohol, ether or ester functionalized branched polyolefin (Pol-C(R²)R³C(R⁴)R⁵OH, Pol-C(R²)R³C(R⁴)R⁵OR¹ or Pol-C(R²)R³C(R⁴)R⁵OC(═O)R¹) can be obtained.

With respect to aziridine, after quenching for example an amine or amide functionalized branched polyolefin (Pol-C(R²)R³C(R⁴)R⁵NR⁶H, Pol-C(R²)R³C(R⁴)R⁵NR⁶R¹ or Pol-C(R²)R³R⁴)R⁵NR⁶C(═O)R¹) can be obtained.

With respect to cyclic anhydride, after quenching for example either a anhydride-acid or anhydride-ester functionalized branched polyolefin (Pol-C(═O)—R²—C(═O)OH or Pol-C(═O)—R²—C(═O)OR¹) can be obtained.

With respect to imine, after quenching for example an amine functionalized branched polyolefin (Pol-CR³R⁴NR²H or Pol-CR³R⁴NR²R¹) can be obtained.

With respect to SO₃, the metal carbon bond is cleaved and the oxidizing agent is inserted to form a Pol-S(═O)₂O-M. After quenching for example either a sulfonic acid or sulfonic acid ester functionalized branched polyolefin (Pol-S(═O)₂OH or Pol-S(═O)₂OR¹) can be obtained.

With respect to a ketone or aldehyde, the metal carbon bond is cleaved and the oxidizing agent is inserted to form a Pol-C(R²)(R³)O-M. After quenching for example an alcohol, ether or ester functionalized branched polyolefin (Pol-CR²R³OH, Pol-CR²R³OR¹ or Pol-CR²R³OC(═O)R¹) can be obtained.

R¹, R², R³, R⁴, R⁵, R⁶ are each independently selected from the group consisting of H, SiR₃⁷, SnR₃⁷ or a C1-C16 hydrocarbyl, preferably a C1-C4 hydrocarbyl, where R⁷ is selected from the group consisting of C1-C16 hydrocarbyl.

In an embodiment, the oxidation step can be carried out for example at a pressure between 0.01 and 80 bar, preferably between 1 and 20 bar, further preferred between 2 and 10 bar. In an embodiment, the oxidation step can be carried out for example at a temperature of between 0° C. and 250° C.

In an embodiment, the oxidation step can be for example carried out for a time period of between 0.5 minutes and 150 minutes, more preferably between 1 minutes and 120 minutes, further preferred between 30 minutes and 60 minutes depending on the reaction temperature and the oxidizing agent.

Step C) Quenching

During step C) a quenching agent can be used to remove the main group metal from the branch ends to obtain polar functionalities. Said quenching step can preferably be carried out using a hydrolyzing agent or another non-protic metal-substituting agent, which can for example remove the metal to get a polar functionality. Step C) can be optional, especially for example if an ether or thioether function is introduced in Step B).

In an embodiment, said quenching agent is a hydrolyzing agent, which is a protic molecule, e.g. water or an alcohol, especially for example such as (acidified) methanol or ethanol, preferably water.

In an embodiment, said quenching agent can also for example be fluorine, chlorine, iodine, bromine or a halogen-containing agent, such as an alkyl halide, releasing a metal-halide or halogen-containing anhydride releasing a metal-carboxylate. In such case step B) can for example be optional in order to obtain halogen atoms as polar functionalities. Typical examples are alkyl halides and anhydrides. In such way a polymer bearing polar halogen atoms as polar functionalities can be obtained. Halogen as used in the present description may thereby mean: fluorine (F), chlorine (Cl), bromine (Br) or iodine (I).

In another embodiment a halogen-containing agent, such as an alkyl halide can also be used as the quenching agent after step B) in order to obtain polar ester or ether functionality.

This leads to a method for preparing polyolefins (Pols), such as polyethylene (PE, HDPE, LDPE, LLPDE), polypropylene (PP) and many others bearing diverse end-group functions including, but not limited to, for example a halogen function (e.g. Pol-Cl), ketone function (Pol-C(═O)R), ketamine function (Pol-C(═NR²)R¹), carboxylic acid function (Pol-COOH), a thiolic acid function (Pol-C(═O)SH, a thionic acid function (Pol-C(═S)OH), a dithio acid function (Pol-C(═S)SH), an alcohol function (Pol-OH), an ether function (Pol-OR¹), an amine function (Pol-N(R²)R¹), a thiol function (Pol-SH), an amidine function (Pol-C(═NR²)N(R³)R¹), an amide function (Pol-C(═O)N(R²)R¹), an ester function (Pol-C(═O)OR¹), a thioester function (Pol-C(═O)SR¹), a dithioester function (Pol-C(═S)SR¹) a hemiacetal (Pol-CH₂CR²═C(OR³)—OH) or an acetal function (Pol-CH₂CR²═C(OR³)—OR¹).

“Pol” as used in the present description means: polyolefin.

“LLDPE” as used in the present description means: linear low density polyethylene. LDPE and LLDPE thereby encompass polyethylene with a density for example between 0.85 and 0.95 kg/m³, that can thus also includes especially for example VLDPE and MDPE.

In an embodiment, branched polyolefins having one or multiple end-functionalized short chain branches can have a number average molecular weight (Me) between 500 and 1,000,000 g/mol, preferably between 1000 and 200.000 g/mol.

The polyolefins having one or multiple end-functionalized branches according to the present invention preferably have a polydispersity index (D or PDI) of between 1.1 and 10.0, more preferably between 1.1 and 5.0, more preferably between 1.1 and 4.0, even more preferably between 1.5 and 2.5.

Using the process according to the present invention, polyolefins having one or multiple functionalized short chain branches can be obtained.

The branched polyolefins having functionalized short chain branches prepared according to the present invention may for example be used to introduce polar properties to enhance the interfacial interactions in polyolefins blends with polar polymers or blends with different polyolefins with PEs. They may be used for example as compatibilizers to improve properties such as adhesion. They may be used to improve barrier properties (especially against oxygen) for polyolefin films. They may be used as compatibilizer to highly polar polymers such as for example starch or for polyolefin-based composites with inorganic fillers such as glass or talcum. They may be used in drug delivery devices or nonporous materials/membranes.

### Examples

The invention is further illustrated by the following non-limiting examples merely used to further explain certain embodiments of the present invention.

General Considerations

All manipulations were performed under an inert dry nitrogen atmosphere using either standard Schlenk or glove box techniques. Dry, oxygen free toluene was employed as solvent for all polymerizations. rac-Me₂Si(Ind)₂ZrCl₂ (zirconocene complex) was purchased from MCAT GmbH, Konstanz, Germany. Methylaluminoxane (MAO, 30 wt. % solution in toluene) was purchased from Chemtura. Diethyl zinc (1.0 M solution in hexanes), tri(isobutyl) aluminum (1.0 M solution in hexanes), Tetrachloroethane-d2 was purchased from Sigma Aldrich. DIBAO is di(isobutyl)(7-octen-1-yl)aluminum, DEZ: diethyl zinc (additional chain shuttling agent).

Method of Analyzing the Products

Several analyses were carried out on the products to determine the yield, the percentage functionalization, the molecular weight and the polydispersity index (D). The yield was determined by weighing the powder obtained. The percentage of functionalization was determined by ¹H NMR carried out at 130° C. using deuterated tetrachloroethane (TCE-d2) as the solvent and recorded in 5 mm tubes on a Varian Mercury spectrometer operating at frequencies of 400 MHz.

Size Exclusion Chromatography (SEC).

The molecular weight (Mₙ) in g/mol and polydispersity index (PDI) were determined by means of high temperature size exclusion chromatography (HT SEC) which was performed at 160° C. using a high speed GPC (Freeslate, Sunnyvale, USA). Detection: IR4 (PolymerChar, Valencia, Spain). Column set: three Polymer Laboratories 13 μm PLgel Olexis, 300×7.5 mm. 1,2,4-Trichlorobenzene (TCB) was used as eluent at a flow rate of 1 mL·min⁻¹. TCB was freshly distilled prior to use. The molecular weights and the corresponding PDI were calculated from HT SEC analysis with respect to narrow polyethylene standards (PSS, Mainz, Germany).

“HT SEC” as used in the present description means: high temperature size exclusion chromatography. Size exclusion chromatography can be used as a measure of both the size and the polydispersity of a polymer.

“polydispersity index (PDI)” as used in the present description means: a value that indicates the distribution of the sizes of polymer molecules (M_{w}/Mₙ). The method of measuring the PDI is explained below. Mₙ is the number average molecular weight and M_{w} is the weight average molecular weight.

### Synthesis of di(isobutyl)(oct-7-en-1-yl)aluminum

Di(isobutyl)(oct-7-en-1-yl)aluminum was synthesized by hydroalumination of excess 1,7-octadiene using di(isobutyl)aluminum hydride at 60° C. for 6 h in a 200 mL Schlenk flask equipped with a magnetic stirrer. The remaining reagents (for example 1,7-octadiene) after the hydroalumination reaction were removed by evacuation.

Copolymerization Procedure.

Copolymerization was carried out in stainless steel Büchi reactors (300 mL). Prior to the polymerization, the reactor was dried in vacuo at 40° C. and flushed with dinitrogen. Pentamethylheptane (70 mL), MAO (Al:cat 760) and DIBAO (1.7 mmol), as a second type of olefin monomer comprising a main group metal hydrocarbyl functionality) were added and stirred at 50 rpm for 30 min. rac-Me₂Si(Ind)₂ZrCl₂ (5.9 μmol) was used as a catalyst. Polymerization was started by addition of DEZ. The reactors were then pressurized to the desired pressure (2 bars) with ethylene. Reaction temperature was 40° C. Reaction time was 15 minutes. At the end of the reaction, the ethylene feed was stopped and the residual ethylene was vented off.

| | | MAO | | | Act. | Tₘ | Mₙ (kg/mol) |
|---|---|---|---|---|---|---|---|
| ref. | Com. | Al:cat | DEZ:Cat. | Com.:cat | (kg/mol · h) | (° C.) ^{c} | (PDI) ^{d} |
| 1 | DIBAO | 760 | 34 | 285 | 1822 | 126.7 | 9.8(5.8) |

Oxidation

Oxidation was performed using CO₂ (8 bar) injected at the end of polymerization for 60 min followed by quenching using precipitation of the polymer in acidified methanol.

Functionalization yield to COOH was found to be 84%. Such yield is surprisingly similar or even better compared to comparative experiments carried out using O₂.

1. A process for the preparation of a polyolefin having one or more pending polar functionalities, said process comprising the step of:
A) a polymerization step comprising copolymerizing at least one first type of olefin monomer and at least one second type of olefin monomer comprising a main group metal hydrocarbyl functionality according to Formula 1a:
R¹⁰⁰₍ₙ₋₂₎R¹⁰¹Mⁿ⁺R¹⁰² (Formula 1a)
using a catalyst system to obtain a polyolefin; wherein said catalyst system comprises a catalyst or catalyst precursor comprising a metal from Group 3-10 of the IUPAC Periodic Table of elements that does not lead to chain transfer polymerization with the main group metal hydrocarbyl functionality of the second type of olefin monomer, and
wherein further M is a main group metal; n is the oxidation state of M; R¹⁰⁰, R¹⁰¹ and R¹⁰² of Formula 1a are each independently selected from the group consisting of a hydride, a C1-C18 hydrocarbyl group, or a hydrocarbyl group Q with the proviso that at least one of R¹⁰⁰, R¹⁰¹ and R¹⁰² is a hydrocarbyl group Q, wherein hydrocarbyl group Q is according to Formula 1b: 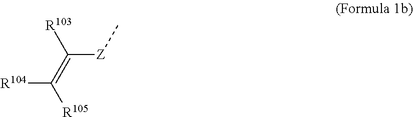
wherein Z is bonded to M and Z is a C1-C18 hydrocarbyl group; R¹⁰⁵ optionally forms a cyclic group with Z; wherein R¹⁰³ and R¹⁰⁴ and R¹⁰⁵ are each independently selected from hydrogen or a hydrocarbyl group; and at least one of the steps of:
B) an oxidizing step comprising contacting said polyolefin obtained in step A) with at least one oxidizing agent to obtain a polyolefin having one or more pending oxidized functionalities; and/or
C) contacting said polyolefin obtained in step A or step B) with at least one quenching agent to obtain a polyolefin having one or more pending polar functionalities.

2. The process according to claim 1, wherein said oxidizing agent used in step B) is an oxidizing agent according to Formula I:
XYₐZ¹_{b}Z²_{c}(Formula I)
wherein a is 1, b and c are each independently 0 or 1 and X, Y, Z¹ and Z² are independently selected from carbon, hydrocarbyl or heteroatom.

3. The process according to claim 1, wherein the oxidizing agent used in step B) is selected from the group consisting of CO, CO₂, CS₂, COS, R²NCO, R²NCS, R²NCNR³, CH₂═C(R²)C(═O)OR³, CH₂═C(R₂)(C═O)N(R³)R⁴, CH₂═C(R²)P(═O)(OR³)OR⁴, N₂O, R²CN, R²NC, epoxide, aziridine, cyclic anhydride, R³R⁴C═NR², R²C(═O)R³, ClC(═O)OR² and SO₃.

4. The process according to claim 1,
wherein at least one of R¹⁰⁰, R¹⁰¹ and R¹⁰² is a hydrocarbyl group Q and the remaining groups of R¹⁰⁰, R¹⁰¹ and R¹⁰² are each a C1-C4 hydrocarbyl group, or
wherein two groups of R¹⁰⁰, R¹⁰¹ and R¹⁰² are each a hydrocarbyl group Q and the remaining group of R¹⁰⁰, R¹⁰¹ and R¹⁰² is a C1-C4 hydrocarbyl group, or
wherein all of R¹⁰⁰, R¹⁰¹ and R¹⁰² are a hydrocarbyl group Q.

5. The process according to claim 1, wherein the hydrocarbyl group Q according to Formula 1b attached to a main group metal is a linear α-olefin group or a cyclic unsaturated hydrocarbyl group.

6. The process according to claim 1, wherein at least one type of olefin monomer comprises a main group metal hydrocarbyl functionality that is selected from the group consisting of bis(isobutyl)(5-ethylen-yl-2-norbornene) aluminum, di(isobutyl)(7-octen-1-yl) aluminum, di(isobutyl)(5-hexen-1-yl) aluminum, di(isobutyl)(3-buten-1-yl) aluminum, tris(5-ethylen-yl-2-norbornene) aluminum, tris(7-octen-1-yl) aluminum, tris(5-hexen-1-yl) aluminum, or tris(3-buten-1-yl) aluminum, ethyl(5-ethylen-yl-2-norbornene) zinc, ethyl(7-octen-1-yl) zinc, ethyl(5-hexen-1-yl) zinc, ethyl(3-buten-1-yl) zinc, bis(5-ethylen-yl-2-norbornene) zinc, bis(7-octen-1-yl) zinc, bis(5-hexen-1-yl) zinc, or bis(3-buten-1-yl) zinc.

7. The process according to claim 1, wherein the co-catalyst is selected from the group consisting of MAO, DMAO, MMAO, SMAO.

8. The process according to claim 1, wherein the metal catalyst or metal catalyst precursor used in step A) comprises a metal from Group 3-8 of the IUPAC Periodic Table of elements.

9. The process according to claim 8, wherein said metal catalyst or catalyst precursor is a Cₛ-, C₁-, or C₂-symmetric zirconium metallocene.

10. The process according to claim 9, wherein said metal catalyst or metal catalyst precursor is [Me₂Si(C₅Me₄)N(tBu)]TiCl₂ or Me₂Si(2-Me-4-Ph-Ind)₂HfCl₂.

11. The process according to claim 1, wherein the at least one type of olefin monomer used in step A) is selected from the group consisting of ethylene, propylene, 1-butene, 4-methyl-1-pentene, 1-pentene, 1-hexene, 1-heptene, 1-octene, 1-nonene, 1-decene, 1-undecene, 1-dodecene, 1-tridecene, 1-tetradecene, 1-pentadecene, 1-hexadecene, 1-heptadecene, 1-octadecene, 1-cyclopentene, cyclopentene, cyclohexene, norbornene, ethylidene-norbornene, vinylidene-norbornene and one or more combinations thereof.

12. A polyolefin obtained by a process according to claim 1 having one or more pending polar functionalities, having a number average molecular weight (Mₙ) between 500 and 1,000,000 g/mol and having a polydispersity index (Ð) of between 1.1 and 10.0 and wherein said polyolefin has a degree of functionalization or functionalization yield of at least 30%, wherein said polyolefin having one or multiple end-functionalized branches is according to Formula I.I
Pol-XYₐZ¹_{b}Z²_{c}R¹_{d} (Formula I.I)
wherein a, b, c and d are each independently 0 or 1 and X, Y, Z¹, Z² are each independently selected from carbon, hydrocarbyl, heteroatom and halogen and R¹ is hydride or hydrocarbyl.

13. The process according to claim 1, wherein an additional main group metal hydrocarbyl chain transfer agent used in step A) is selected from the group consisting of: hydrocarbyl aluminum, hydrocarbyl magnesium, hydrocarbyl zinc, hydrocarbyl gallium, hydrocarbyl boron, hydrocarbyl calcium and one or more combinations thereof.

14. The polyolefin according to claim 13, wherein a, b and d are 1, c is 0, and X is C, Y and Z¹ are O and R¹ is H.

15. The polyolefin obtained by a process according to claim 1, wherein each short chain branch comprises a substituted or unsubstituted alkyl chain and/or a bridged or unbridged, substituted and/or unsubstituted, cyclic hydrocarbon comprising 1 to 25 carbon atoms.

16. The process according to claim 7, wherein
the oxidizing agent used in step B) is selected from the group consisting of N₂O, CO₂ and SO₃;
the hydrocarbyl group Q according to Formula 1b attached to a main group metal is 5 preferably but-3-en-1-yl, pent-4-en-1-yl, hex-5-en-1-yl, hept-6-en-1-yl or oct-7-en-1yl, 5-ethylenebicyclo[2.2.1]hept-2-ene or 5-propylenebicyclo[2.2.1]hept-2-ene;
the co-catalyst is in combination with an aluminum alkyl or with an aluminum alkyl and a fluorinated aryl borane or fluorinated aryl borate;
the metal catalyst or metal catalyst precursor used in step A) comprises a metal selected from the group consisting of Ti, Zr, Hf, V, Cr, Fe, Co, Ni, Pd, preferably Ti, Zr or Hf.

17. The process according to claim 16, wherein
the co-catalyst is in combination with triisobutyl aluminum; and
wherein the metal catalyst or metal catalyst precursor used in step A) comprises an indenyl substituted zirconium dihalide.

18. The process according to claim 16, wherein the metal catalyst or metal catalyst precursor used in step A) is rac-dimethylsilyl bis-indenyl zirconium dichloride (rac-Me₂Si(Ind)₂ZrCl₂) or rac-dimethylsilyl bis-(2-methyl-4-phenyl-indenyl) zirconium dichloride (rac-Me₂Si(2-Me-4Ph-Ind)₂ZrCl₂.
